(19) United States
(12) Patent Application Publication
(10) Pub. No.: US 2010/0302136 A1
(43) Pub. Date: Dec. 2, 2010

(54) Method and apparatus for displaying three-dimensional stereo images viewable from different angles

(76) Inventor: Salvatore Arcuri, San Ramon, CA (US)

Correspondence Address: SALVATORE ARCURI, 3659 CROW CANYON ROAD, SAN RAMON, CA, 94582, US

(21) Appl. No.: 12/455,475

(22) Filed: Jun. 1, 2009

(51) Int. Cl. G06F 3/01; G02B 27/22

(52) U.S. Cl. 345/156; 359/464

(57) ABSTRACT

A method and apparatus for displaying three-dimensional stereo images using a screen that displays multiple images, each representing objects seen from a particular angle, and a mask placed in front of the screen, containing holes or transparent areas, that allows multiple images to be viewed simultaneously, but only one image from any given direction.

Multiple persons can simultaneously perceive stereo vision of the same display, without the need to use special glasses, because the two eyes of the same person will look at the screen from different angles and will see different images. As people move to new positions that change the angle of view, new views will be exposed and the viewers will see different sides of the objects.

This will provide a very realistic stereovision without the need of special glasses.

Alternatively, only two views may be displayed.

### 2. BACKGROUND OF THE INVENTION

2.1. Field of the invention

The field of this invention is that of methods for displaying three-dimensional television and three-dimensional computer graphics in stereo vision.

2.2. Description of related art

The most common way of displaying three-dimensional stereo images is through the use of glasses whose transparency is controlled electronically in synchronism with two different images applied to the display, to allow the wearer of the glasses to see two different images of the same scene, one for the left eye and one for the right eye, as they would appear by looking at a real scene in three dimensions. The wearer of the glasses gets the impression of depth in the scene and perceives the objects to be three-dimensional.

Illusion of three-dimensions is produced by looking at a picture of a scene with the left eye and at another picture of the same scene with the right eye, where the two pictures represent respectively the scene as seen by left eye and the scene as seen by the right eye.

This technique is inconvenient since it requires users to wear special glasses in order to view the image in stereo mode. Another alternative is to view the image through a special viewer. This is also inconvenient because it requires the user to hold the viewer close to the eyes.

A stereo display using glasses or a viewer provides only two images. When a person moves around to try so see a different side of the object, he or she will discover that a new view of the object does not appear.

Two patents, U.S. Pat. No. 5,771,121 and U.S. Pat. No. 7,215,356 B2 describe stereo vision systems using two images that can be viewed through a screen mask, providing one image for the left eye and one image for the right eye.

U.S. Pat. No. 5,465,175 describes an invention using a light source, a modulator and a screen mask. A web page described an implementation by Philps of a three-dimensional display system that produces multiple views using miniature lenses.
Some stereovision displays that do not require glasses use an array of micro lenses to display multiple images. With these displays the number of views is small and the fabrication requiring lenses complicated.

### 3. THE INVENTION

### 3.1. Brief Summary of The Invention

This invention consists of a method and apparatus to build a computer graphics or video display system that can present separate images for different angles of view, thus allowing different images to be viewed by different eyes of the same person or of different persons.

Thus multiple persons can look at the screen simultaneously or the same person can look at the screen from different positions. In some variations, only one person can look at the screen at a given time. The different variations of the technique allow manufacturers to build more or less sophisticated systems with varying costs.

The basis of the invention consists of a luminous display upon which multiple views of the same scene can be represented, and a mask with appropriate openings that allows a particular view of the scene to be visible only from a particular angle. The number of views of the scene and the number and organizations of angles from which the multiple views can be viewed vary.

The number of views of the scene and the number of simultaneous angles can be controlled electronically, by controlling the position and the sequence of areas where portions of the images are represented on the display, and the position and the sequence of transparent areas on the mask.

In a variation of this invention, the display and the mask can be combined, by allowing the mask to be used multiple times for the same angle of view to modulate the light intensity, allowing the light to pass through the mask with different intensity depending on the direction. In this way the mask controls the light density and the direction of view.

The display may be reduced to an array of light sources that need to be controlled only in their on or off position in sequence.

### 3.2. BRIEF DESCRIPTION OF DRAWINGS

FIG. 1 illustrates a combination of a screen mask (1) and a display (2).

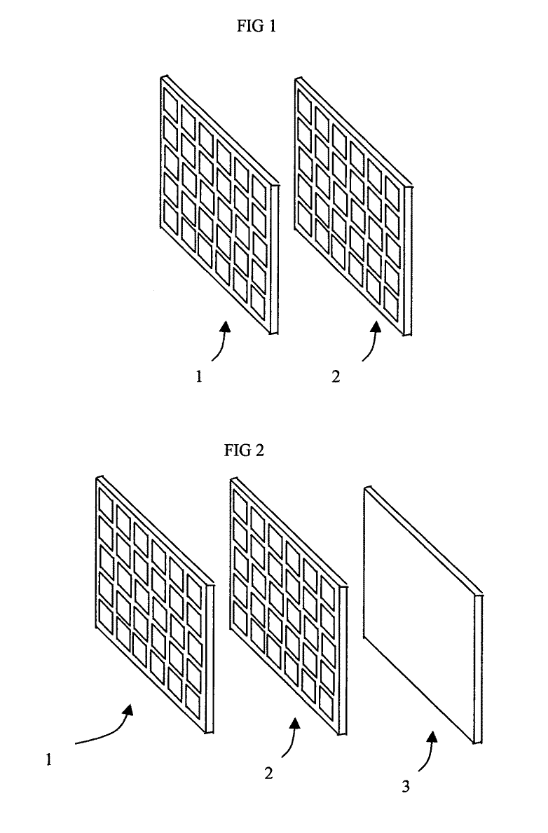

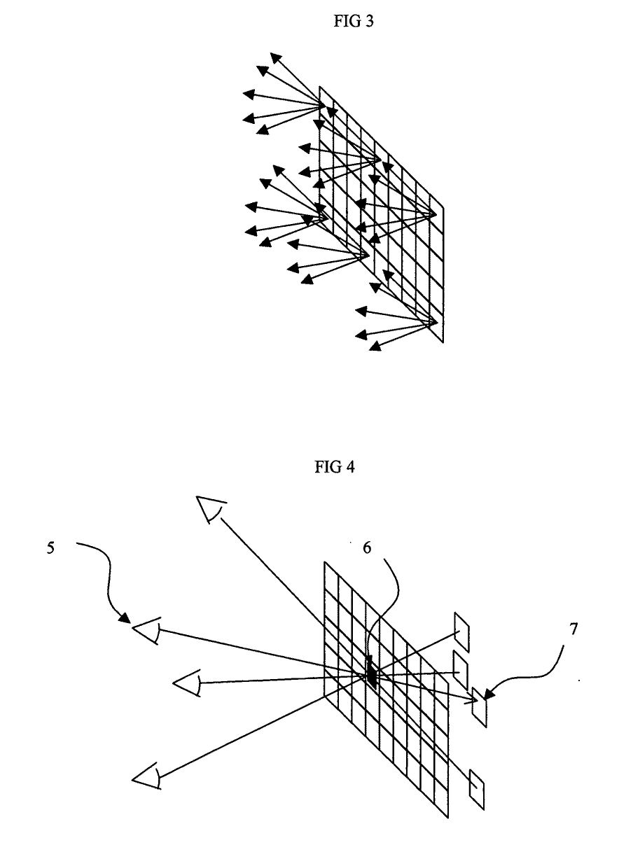

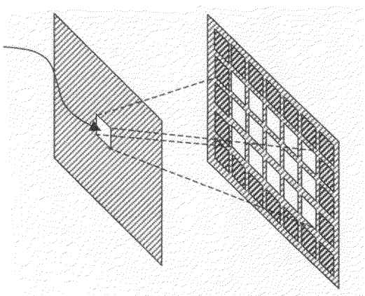

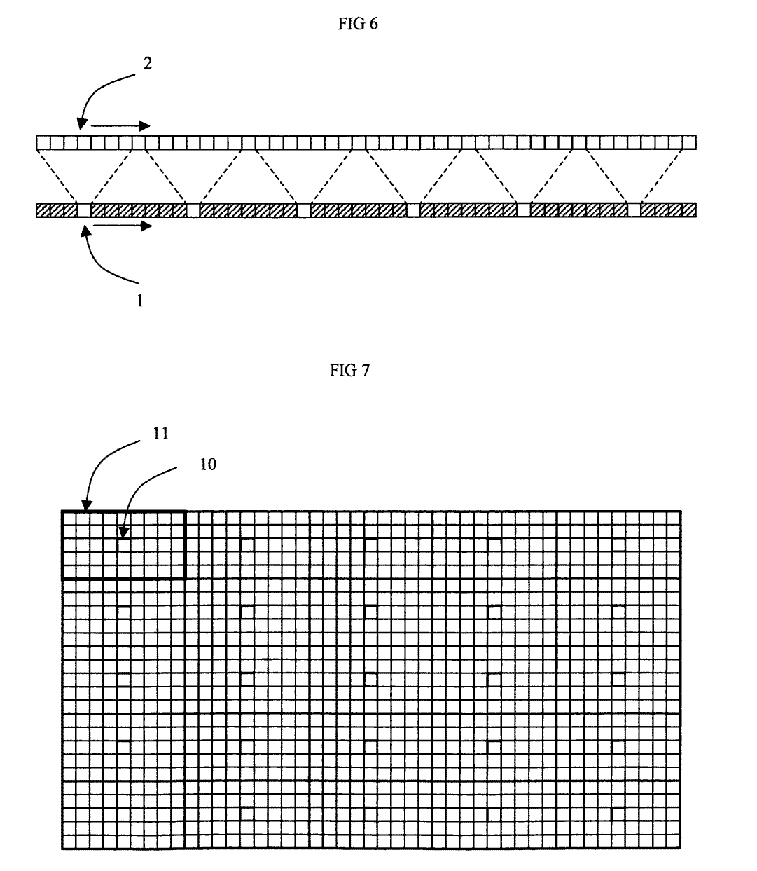

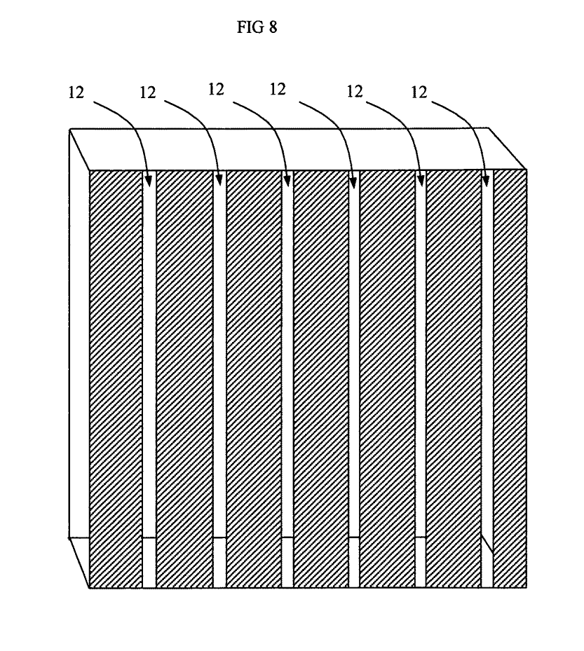

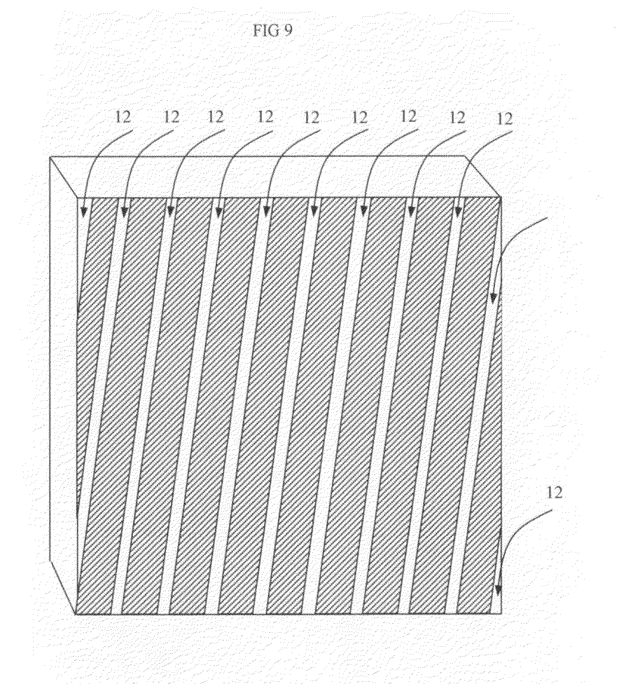

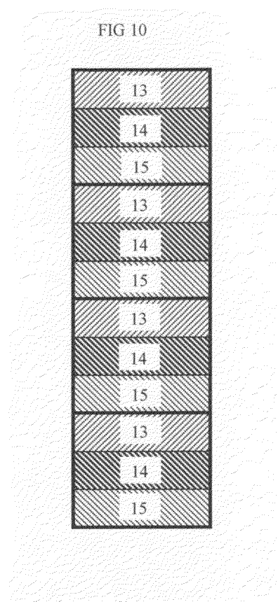

FIG. 2 illustrates a combination of a screen mask (1), a display mask (2) and a light source (3).
FIG. 3 illustrates how different images can be viewed from different directions.
FIG. 4 illustrates how an eye (5) at a certain position can view only one pixel (7) among a group of active pixels on the display, through a hole (6) made transparent in the mask.
FIG. 5 illustrates how a transparent hole in the mask allows viewing only one pixel of a group of active pixels from a particular direction.
FIG. 6 illustrates a cross section of the mask (1) and the display (2) and how transparent holes in the mask can be made to become transparent in sequence, and how pixels can be made to become active in sequence.
FIG. 7 illustrates how for each transparent hole there corresponds a group of pixels in the display.
FIG. 8 illustrates how holes can be organized in stripes (12).
FIG. 9 illustrates how stripes can be made to have any angle.
FIG. 10 illustrates how red, green and blue sub pixels can be organized in case of the use of an active display.

### 3.3. DETAILED DESCRIPTION OF THE INVENTION

A mask with a two-dimensional array of holes is placed in front of a display that displays a two-dimensional array of pixels, such that from each hole of the mask, only one pixel of the array of pixels can be seen from any particular direction.

In one variation the number of pixels is greater that the number of holes. If each array of pixels consists of M×N pixels, the number of pixels will be M×N times greater than the number of holes.

In another variations, the number of pixels is the same as the number of holes, but holes are made transparent in sequence, so that each pixel in an M×N array of pixels can be seen only from one hole at a time. Each pixel of the M×N array of pixels will be visible through the hole but only from a particular direction.

The invention uses the principle of the photographic camera, that ensures that a point in space is projected only to one point on a surface inside the camera by forcing the light to pass through a small hole. A point on the surface inside the camera and the transparent hole of the camera, identify a line of view, and thus that point can be seen only from an eye located on the line of view.

A pixel to be displayed and a hole on the mask, if they are small enough, define only one line of view, and therefore that pixel can be seen only from an eye looking at that pixel in that line of view. Multiple pixels and a hole produce multiple lines of view.

There is no fixed number of lines of view to be provided and of the number of views that can be supported.

In a very sophisticated implementation the number of possible angles could for instance allow a number of points of view in a vertical area of 3.99 m ×1.99 m, placed on a grid of one centimeter by one centimeter. This means that the screen could be viewable from 399×199=79,401 angles.

Thus every pixel could be represented simultaneously in 79,401 different versions, each satisfying the proper viewing angle of an eye in that line of view. The reason for the selection of odd numbers is so that the hole can be centered inside the cone of viewing angles, but selecting an even number of pixels is also possible.

All pixels will send the light in 79,401 directions, allowing the viewers to move left or right, up or down or rotate the position of the head, within a viewing range and still be able to perceive the three-dimensional effect.

This number is very large, and it would require the generation of a lot of image data. A smaller number would be achieved by providing 99 horizontal angles and 9 vertical angles, for a total of 891 different directions. An even smaller number would be achieved allowing 9×5 =45 different directions. Various compromises in the horizontal and vertical direction are possible.

Convenient numbers of angles of view are

45 angles corresponding to 9×5 pixels per hole,
465 angles corresponding to 31×15 pixels per hole,
945 angles corresponding to 63×15 pixels per hole,
891 angles corresponding to 99×9 pixels per hole ,
79,401 angles corresponding to 399×199 pixels per hole,
but other number of angles are also possible.
There are two basic approaches to implement this invention.

In one approach the image will be broken down into an array of image portions. Each portion of the image will consist of 399×199 or 99×9 or 9×5, etc., pixels. The mask will contain many holes, each hole placed in front of the center for each image portion. Each hole in the mask will allow only one pixel of the corresponding image portion to be viewed from a particular direction.

All pixels of a portion of image can be activated at the same time, because one and only one pixel of the portion will be visible from any viewing angle through the hole in the mask.

In another approach the image will be broken down in 399×199 or 99×9 or 9×5, etc., pixels as in the previous approach, but the mask will have one hole in front of each pixel, except at the borders where some additional holes are needed. The holes are controlled electronically. Holes and image portions will be activated in sequence. Holes that are transparent at any one time are far enough from each other in order to not allow the same area of the screen to be visible at the same time from more than one transparent hole. In sequence all holes of the mask will be made transparent for a certain amount of time. Pixels of a portion can all be activated at the same time, but active portions must be separated enough from each other in order not to allow their pixels to be seen from multiple holes at the same time, and transparent holes must be separated enough from each other in order not to allow pixels of different portions to be seen from multiple holes at the same time.

The images can be drawn in multiple phases. At every phase all the pixels of a group surrounding the pixel in front of the transparent hole can be activated. Pixels that are being processed must be far enough from the next pixels being processed to guarantee that no pixels of different group overlap during a phase. With multiple phases all pixels will be covered.

In sequence all holes will be opened and closed, so that the whole mask will have been covered. This sequence is fast enough to not allow viewers to perceive flicker.

The mask needs to be thin enough to allow the required number of holes to be made in the mask and being able to view the pixels through them at a maximum angle, which for instance can be 45 degrees.

The mask consists of an opaque surface containing visual holes that can be controlled electronically into the transparent or non-transparent mode. The preferred method of constructing the mask is that of using a screen of liquid crystals that is controlled electronically to produce transparent areas that form the visual holes.

It is possible to further reduce the number of vertical angles to one and the number of horizontal angles to two in order to reduce the amount of image data that needs to be displayed. In this way groups of transparent holes will form lines, or transparent slots. These slots allow one eye to see one view or field of the scene and the other eye to see the other view or field. It is possible to organize the lines so that their orientation is not fixed to vertical, but can be adapted to be always perpendicular to the line joining the two eyes. The orientation of the eyes can be detected with a camera and some image recognition software.

Slots can be controlled in sequence to scan the whole image.

To improve the selectivity of the image, in the case where the holes are organized as lines, the distance between the mask and the display may be controllable by a motor to be adapted as a function of the distance of the viewers from the mask in order to make sure that areas viewed by the left eye do not overlap with areas viewed by the right eye.

Any display type can be behind the mask. Possible types of displays are liquid crystal displays, plasma displays, CRT displays, OLED displays or a projection screen.

Stereovision can be accomplished by using the mask of liquid crystal placed between the viewer and the display.

The liquid crystals will open holes in front of the display where light can pass through and remain in non-transparent mode in areas where light must not pass through, and will thus isolate portions of the display that can be viewed from particular directions.

Stereovision requires two images of the same scene. One image corresponding to the way the scene appears to left eye and one image corresponding to the way the image appears to the right eye.

In this invention several images and not just two can be displayed. This allows each eye of a person to see a different image, but also eyes of other persons or the same eyes but in different positions to see different images.

A display that can present only two views can be viewed only by one position, and thus it can be viewed only by one viewer. To allow the display to be viewable from multiple points of view or to allow multiple people to view the display at the same time, the display is made to present several views.

When a person changes the angle of view, a display that can present only two views does not allow the persons to see a different side of the image when the person changes the angle of view. With the current invention this problem is reduced, and a more realistic representation of three-D vision can be obtained. A display capable of presenting multiple views can allow people when changing the angle of view to see sides of the images that were not visible from a previous angle of view.

The display and the mask can be combined, by allowing the mask to be used multiple times for the same angle of view to modulate the light intensity according the intensity of the pixel that needs to be seen from a particular angle of view.

The display may in this case be simplified, and reduced to an array of light source that need to controlled only in their on or off positions is sequence.

### 3.3.1. The Frame Buffers

The frame buffer consists of several buffers, each containing a view of the scene to be displayed.

Multiple frames, one for each supported angle of view, are needed with this invention. The frames may be placed into a larger frame buffer prior to being sent to the display or may be built on the fly, by extracting fragments of frame from smaller frame buffers, and sending them to the display.
The frames can be contained in a special region of memory or can be assembled by using pointers to read data from different regions of memory.

### 3.3.2. The Display

The display can be a passive liquid crystal display, an active matrix liquid crystal display, a CRT, a plasma display, an OLED display, a projection screen or another type of display. In general any display in front of which a mask can be placed without interfering with the ability to place data on the display, can to be used as a display for this invention.

Although until now the invention has been presented as a combination of a display and a mask as a complete unit, the invention can also be implemented as a separate panel containing only the mask made of liquid crystal shutters or other optical methods, which can be attached to a generic flat-surface CRT or monitor or flat panel display.

The refresh rate of the display must be a few times the refresh rate that the display would have had if the mask were not present.

Although this is possible, achieving high refresh rates poses technical difficulties, since the pixel rate becomes higher and the digital-to-analog converters that convert the signals into analog for display have to operate at higher frequency. This problem could be reduced by breaking down the scanning of the display into several sections that would be scanned simultaneously.

This problem can be addressed more easily with flat panel displays, which do not require an electronic beam or deflection circuits. In this case the area of the display can be split into several groups of pixels, which can be controlled simultaneously with separate addressing logic.

Displays can have different areas for red, green and blue pixels, and each pixel can consists of sub-pixels red, green, blue or other combinations of colors, or can use the same pixel area for each primary color in sequence.

I claim:

1. An apparatus for displaying three-dimensional images, comprising a display screen upon which multiple images can be represented, each image being represented on a subset of the pixels of the display, and a mask containing visual holes or transparent areas, said mask placed at a distance from the display screen and the holes of said mask being small enough and far enough from each other such that only the pixels of the display screen, corresponding to one image, can be viewed through the mask when the display screen is viewed through said mask from a particular angle.

2. An apparatus for displaying three-dimensional images, comprising a display screen upon which multiple portions of images can be represented, and a mask containing visual holes or transparent areas, said mask placed at a distance from the display screen and the holes of said mask being small enough, and electronically controlled to be transparent or non transparent in sequence, such that from any transparent hole only pixels in a group of pixels of the display screen near the transparent hole can be viewed, and from any transparent hole only one pixel of the group of pixels near the transparent hole can be viewed from any particular direction, and such that controlling all holes to be transparent in sequence, all holes will be made transparent for some of the time it takes to scan a frame, and while a hole is transparent other holes can be transparent simultaneously, provided that they are far enough from the other transparent holes that no pixel of the display screen can be viewed simultaneously from two or more transparent holes.

3. An apparatus according to claim 2 where the group of active pixels and holes are organized to form stripes, so that one image is visible through one eye and one image through the other eye, and the groups of pixels and transparent holes are scanned to cover both images in sequence where the stripes are positioned to any arbitrary position and angle, in order to be perpendicular to the line joining the eyes of an observer.

4. An apparatus according to claim 1 or 2 or 3 where the distance of the mask from the display is adjustable through a motor or some mechanical actuator.

5. An apparatus according to claim 1 or 2 or 3 or 4 or where a camera or other eye or head tracking device is used to detect the position of the head and this information is used to adaptively adjust the orientation of the stripes or the distance of the mask from the display.

6. An apparatus according to claim 1 or 2 or 3 or 4 or 5 where a camera or other eye or head tracking device is used to detect the position of the heads and to provide use of this position information to adaptively adjust the number of images to be displayed and the distance of the mask from the display.

7. An apparatus according to claim 2, where the display is replaced with light sources that control the pixels to on or off condition and do not modulate them and where the modulating function is performed by the mask.
